(19) United States
(12) Patent Application Publication
(10) Pub. No.: US 2007/0139186 A1
(43) Pub. Date: Jun. 21, 2007

(54) Circuit configuration for transmission of data signals from and/or to household appliances

(75) Inventors: Udo Hertel, Regensburg (DE); Simon Piermeier, Sankt Englmar (DE)

Correspondence Address: LERNER GREENBERG STEMER LLP, P O BOX 2480, HOLLYWOOD, FL, 33022-2480, US

(73) Assignee: BSH Bosch und Siemens Hausgerate GmbH

(21) Appl. No.: 10/584,166

(22) PCT Filed: Dec. 22, 2004
(86) PCT No.: PCT/EP04/53656

§ 371 Date: Oct. 16, 2006

(30) Foreign Application Priority Data
Dec. 22, 2003 (DE) 103 60 565.7

(51) Int. Cl. G08B 1/08

(52) U.S. Cl. 340/538.12

(57) ABSTRACT

Data signals are transmitted from and/or to household appliances between a first transceiver device and a second transceiver device via an AC power supply line system within a transmission frequency range that exceeds the frequency of the AC power supply. The respective transceiver device is connected to the AC power supply line system by way of a filter array having a power supply low pass filter connected in the input circuit of a power supply unit of the associated transceiver device and is provided with an impedance curve such that its impedance in the transmission frequency range has a value that is at least twice as high as the impedance of the AC power supply line system in the transmission frequency range.

The invention relates to a circuit configuration for the transmission of data signals from and/or to household appliances between a first transceiver device and a second transceiver device via an AC power supply line system within a transmission frequency range which lies above the frequency of the AC power supply, wherein the respective transceiver is connected to a filter arrangement at the AC power supply line system.

In a known circuit configuration of the aforesaid type (D1: U.S. Pat. No. 6,396,392 B1) the respective transceiver comprises a modem connected to the respective household appliance which is connected to the AC power supply line system via a coupler. Various filters such as low-pass filters are contained both in the modem and in the coupler and the respective coupler is impedance-matched to the impedance of the AC power supply line system both on the input side and on the output side (see in particular FIG. 2 and FIG. 11 of U.S. Pat. No. 6,396,392 B1). In this connection, nothing is known about using filter arrangements in the AC power supply input circuit of the respective household appliance.

In a further known circuit configuration for the transmission of data signals from and/or to household appliances (D2: U.S. Pat. No. 6,590,493 B1), in each case a group of individual household appliances is connected to an AC power supply line system via a separate filter arrangement. The filter arrangements of different groups of household appliances are dimensioned so that the data signals transmitted in one group of household appliances cannot reach the household appliances belonging to another group of household appliances. LC low-pass filters of different configurations are used for the relevant filter arrangements. In this connection, nothing is known about problems with matching the impedances of these filter arrangements to the impedance of the AC power supply line system.

To avoid HF interference signals being emitted from a household appliance connected to a AC power supply line system, it is generally known (D3: Siemens Switching Examples, 1974/75 edition, page 128, FIG. 6.4 and page 129, FIG. 6.5) to connect a capacitor arrangement between the voltage-carrying power supply line and a neutral conductor, this capacitor arrangement comprising a series circuit of two capacitors (known as Y capacitors) of relatively low capacitance whose common connection point is connected to an ground connection of the relevant power supply of the relevant household appliance. Optionally, a higher-capacitance single capacitor (known as an X capacitor) is connected in parallel to this capacitor series circuit. Matching of the impedance of the AC power supply input circuit of the relevant household appliance to the impedance of the power supply line supplying the AC voltage is not provided here.

In addition to the interference suppression measure last considered it is further known (D4: Siemens Switching Examples, 1977/78 edition, page 137, FIG. 6.4 and page 152, FIG. 6.8) to provide a current-compensated choke arrangement in the AC power supply input circuit, comprising two choke windings of which one is located in the current-carrying power line and the other lies in the relevant neutral conductor. This type of current-compensated choke arrangement prevents common-mode interference pulses originating from the relevant appliance from entering into the power supply. In this case also, nothing is known about any matching the impedance of the filter arrangement used in the AC power supply input circuit of the relevant household appliance to the impedance of the AC power supply line system.

In a circuit configuration of the type specified initially, it has now been established that a filter arrangement used hitherto in conjunction with the respective transceiver device similar to the filter arrangement known from D1 with the usual dimensions can substantially reduce the respectively emitted transmission level at the AC power supply line system so that these signals can only be received without interference over a relatively short distance by a receiver device connected to the AC power supply line system.

It is thus the object of the invention to show a way of constructing a circuit configuration of the type specified initially with a relative low filter expenditure whilst avoiding the disadvantage indicated hereinbefore.

The object indicated hereinbefore is achieved in a circuit configuration of the type specified initially by the respective filter arrangement containing a power supply low-pass filter which is arranged in the input circuit of the power supply unit of the associated transceiver device and is provided with an impedance curve such that the impedance thereof in said transmission frequency range has a value that is at least twice as high as the impedance of the AC power supply line system in said transmission frequency range.

The invention has the advantage that as a result of said dimensioning of the power supply low-pass filter which is arranged in the input circuit of the power supply unit of the associated transceiver device, the transmission level delivered by the relevant transceiver device to the AC power supply line system is not reduced so substantially as is the case when using the filter arrangement used so far. The dimensioning of the afore-mentioned power supply low-pass filter according to the invention will be discussed in further detail below. At this point, it may be noted that a transceiver device is understood to be a transmitting and/or receiving device according to the case.

Appropriately in an AC power supply line system comprising at least one current-carrying line conductor and an ground conductor, the power supply low-pass filter consists of an inductive component located in the respective line conductor and a capacitor arrangement located between at least one end of the relevant inductive component and the ground conductor. This yields the advantage of a power supply low pass filter which is particularly easy to implement.

The afore-mentioned capacitor arrangement preferably consists of a single capacitor (X capacitor) which connects the end of the inductive component on the power supply unit side to the ground conductor of the AC power supply line system and a series circuit of two capacitors (Y capacitors) connected in parallel to this single capacitor, whose common connection point is connected to the ground connection of the relevant power supply unit. A capacitor arrangement having this structure thus particularly effectively prevents HF interference signals produced in the relevant household appliance or the relevant transceiver device from entering into the AC power supply line system.

An ohmic resistor is appropriately connected in parallel to said capacitor arrangement. This ohmic resistor advantageously serves to unload the capacitor arrangement after disconnecting the entire circuit configuration from the AC power supply line system so that in this state no problems arise through contact of otherwise current-carrying lines or part of the relevant circuit configuration.

In order to avoid common-mode interference signals from the respective household appliance or the respective transceiver device being delivered to the AC power supply line system, preferably respectively one winding of a current-compensated choke is inserted in the conductor sections of the power supply low pass filter connected to the respective line conductor and the ground conductor of the AC power supply line system.

The invention is explained in detail hereinafter using an exemplary embodiment with reference to the drawings.

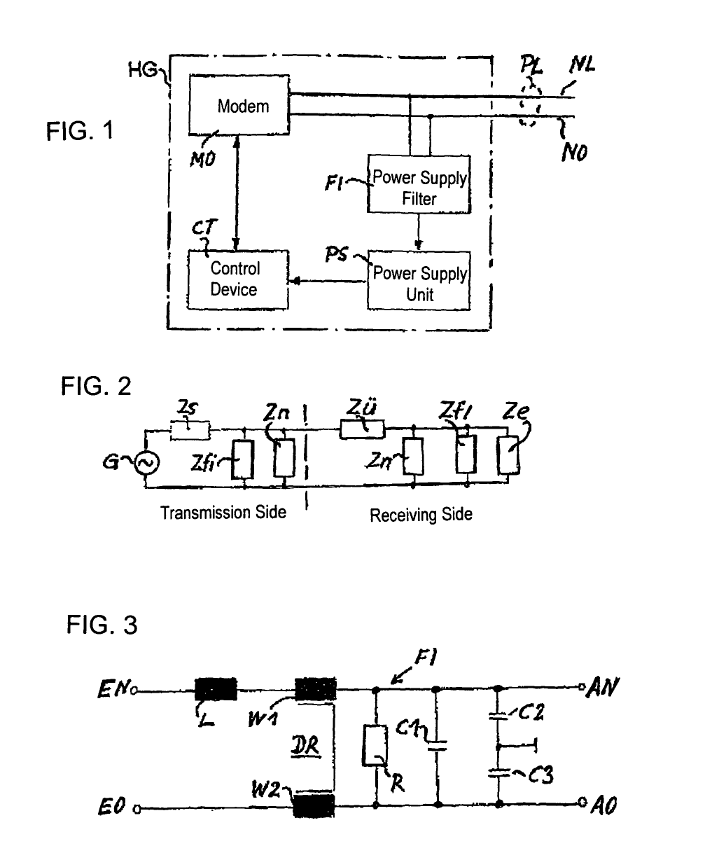

FIG. 1 shows a schematic diagram of a circuit configuration according to one embodiment of the present invention.

FIG. 2 illustrates in an equivalent circuit diagram the impedance relationships on the transmission side and on the receiving side in circuit configurations of the type shown in FIG. 1.

FIG. 3 shows the structure of a power supply low pass filter as used in a circuit configuration according to FIG. 1.

FIG. 1 shows an embodiment of a circuit configuration according to the present invention belonging to a household appliance HG. The household appliance concerned can be any networkable household appliance such as a washing machine, a drier, a cooker, a refrigerator, a heating system etc. A networkable household appliance is to be understood here as a household appliance which can be connected to a communication network for the transmission of various data signals by means of a transmitting and/or receiving device. In the present case, this communication network comprises the AC power supply from which the supply voltages required for operation of the respective household appliance are taken.

The circuit configuration according to FIG. 1 comprises a transceiver device in the form of a modem whose transmission output and whose receiving input are connected to an AC power supply line system PL of the aforesaid AC power supply. In the present case, the AC power supply line system merely comprises a current-carrying conductor line NL and an ground conductor NO; the relevant AC power supply line system is thus a single-phase AC power supply line system. However, a multiphase AC power supply line system can also be used.

Furthermore, a power supply filter FI is connected to the two lines NL and NO of the AC power supply line system NL on the input side. In the present case, this power supply filter FI is a power supply low pass filter which attenuates the AC power supply at the AC power supply frequency of 50 Hz or 60 Hz very little if at all. The impedance of the associated low-pass power supply filter FI at the AC power supply frequency is of the order of magnitude of a few milliohms. On the other hand, the impedance of the relevant low-pass power supply filter FI in the transmission frequency range in which data signals are transmitted from the modem MO and/or to said modem is substantially higher, being in the range of a few ohms. This will be discussed in further detail below.

The power supply filter FI considered previously is connected before the input of a power supply unit PS which provides the various supply voltages required by the individual devices or appliance parts of the household appliance HG under consideration. In the present case, merely a control device CT is shown as representative of all the devices of the household appliance HG provided which have their supply voltages supplied from the power supply unit PS. The control device CT is connected to the modem MO via control lines for bidirectional signal transmission. This means that the modem MO receives control signals supplied by the control device CT and that conversely signals for processing are fed to the control device CT from the modem MO. These signals are usually obtained from the transmission of data signals which are delivered from the modem MO via the AC power supply line system PL and/or which are supplied to the modem MO via this AC power supply line system PL.

The modem MO operates here as an AC power supply or powerline communication device, for example, in a working or transmission frequency range of 95 kHz to 148.5 kHz. This transmission frequency range is thus significantly higher than the power supply frequency (50 Hz or 60 Hz) of the AC power supply.

The relevant household appliance HG or more accurately its relevant transceiver, that is the modem MO, is in communicating connection with at least one second transceiver for transmission of data signals via the AC power supply line system PL. The relevant second transceiver can belong to a further household appliance or for example, to a common control and monitoring device provided for a plurality of household appliances. Data signals can be transmitted between this control and monitoring device and the individual transceivers of the respective household appliances via the AC power supply line system, for example in the course of updating control programs for the individual household appliances and/or for carrying out remote diagnoses in the relevant household appliances.

The equivalent circuit diagram shown in FIG. 2 will be discussed to explain the measures according to the invention taken in connection with the transmission of data signals in the circuit configuration shown in FIG. 1. In the left half this equivalent circuit diagram shows the impedance relationships which are relevant to the transmission side of a first transceiver device, that is for the case where in the circuit configuration shown in FIG. 1, data signals are transmitted by the modem MO via the AC power supply line system PL. These data signals may be generated by a generator G shown schematically in FIG. 2 which may have an impedance Zs of about 1 Ohm at a transmission frequency of, for example, 132.5 kHz.

The power supply line impedance Zn effective between the power supply conductor NL and the ground conductor NO of the AC power supply line system PL forms, together with the transmission-side impedance Zs, a voltage divider through which only a fraction of the amplitude of the data signals delivered by the generator G is decreased at the power supply impedance Zn. At a usual or typical power supply impedance Zn of about 3 Ohm at the aforementioned transmission frequency of, for example, 132.5 kHz, the original transmission amplitude is therefore only decreased by 75% at this power supply impedance.

In order that this amplitude should not be lowered considerably further, it is provided according to the invention that the low pass power supply filter FI whose impedance Zfi is in parallel with the power supply impedance Zn, in the transmission frequency range of the modem MO, that is in the present case at a frequency of 132.5 kHz, should be given an impedance which is at least twice as high as the impedance Zn in the relevant transmission frequency range. If for the numerical values given previously, the impedance Zfi at the frequency of 132.5 kHz is specified, for example, as 6 Ohm, the total impedance of Zn and Zfi is now 2 Ohm. This means that now only two-thirds, that is about 67.1% of the voltage amplitude of the data signal amplitude delivered by the generator G is available on the AC power supply line system PL.

If an impedance Zfi of 12 Ohm, that is four times the power supply impedance Zn, were to be given to the low pass power supply filter FI at the aforementioned frequency of 132.5 kHz, for example, this would give a total impedance between the power supply line NL and the ground conductor NO of the AC power supply line system PL of 2.4 Ohm. As a result, about 70% of the amplitude of the data signal amplitude delivered by the generator G would be available on the AC power supply line system, that is, more than in the case considered previously. As a result of this measure, the range for the transmission of data signals is increased significantly compared with the case where very low-resistance power supply filters FI are used, that is power supply filters which, at the afore-mentioned frequency of 132.5 kHz for example, have an impedance of the order of magnitude of the impedance of the AC power supply line system or even an impedance below this impedance.

At this point, it may be noted that the previously indicated effect of weaker attenuation of the AC power supply line system could be achieved in principle by an even higher-resistance low pass filter at the transmission frequency under consideration. However, this would necessitate an increased expenditure on circuitry which is undesirable. In any case, the measure according to the invention yields a power-supply low-pass filter optimised with regard to impedance relationships with relatively low expenditure on circuitry.

The right half of the equivalent circuit diagram according to FIG. 2 shows the impedance relationships which are relevant to the receiving side of a circuit configuration of the type shown in FIG. 1. As can be seen, a transmission line impedance Zü of the AC power supply line system leading to the relevant receiving side initially has an effect on the receiving side. This impedance Zü can be, for example, 3 Ohm.

The incoming data signals via the impedance Zü on the receiving side of a second transceiver device are effective at the impedance Zn of the AC power supply line system on the receiving side. This impedance Zn, which can be 3 Ohm for example as specified above, firstly lies parallel to the impedance Zfi of the power supply low-pass filter provided on the receiving side and also the input impedance Ze of the circuit configuration provided on the receiving side lies parallel to the parallel circuit comprising the impedances Zn and Zfi. As a result of this parallel circuit, an overall relatively low input receiving level is obtained on the receiving side. In order not to allow this input receiving level to drop so sharply, the impedance Zfi of the power supply low pass filter provided on the receiving side is set in the transmission frequency range of the entire arrangement so that it has a value at least twice as high as the impedance Zn of the AC power supply line system in the aforementioned frequency range. The input impedance Ze on the receiving side should also be selected to be relatively high.

FIG. 3 shows the basic structure of a power supply low pass filter FI used in the circuit configuration according to the invention according to one embodiment. Between an input connection EN and an output connection AN, as important components for the low pass filter characteristic, the relevant power supply low pass filter FI contains an inductive component L, such as a choke coil, and a capacitor arrangement C1, C2, C3 located between one end of the relevant inductive component L and connecting line provided between an input connection E0 and an output connection A0. In the circuit configuration according to FIG. 1, the aforementioned input connection EN is connected to the line conductor NL and aforementioned input connection E0 is connected to the ground conductor N0. The power supply unit PS shown in FIG. 1 is connected to the output connections AN and A0 according to FIG. 3 on the input side.

The aforementioned capacitor arrangement consists of a single capacitor C1, also designated as an X capacitor, which connects the inductive component L at the power supply unit end to the ground conductor of the AC power supply line system and a series circuit of two capacitors, also designated as Y capacitors, connected in parallel to the single capacitor C1. The common connection point of the two aforementioned capacitors C2 and C3 is connected to the ground connection of the relevant power supply unit PS.

Connected in parallel to the capacitor arrangement considered previously, consisting of the capacitors C1, C2 and C3, as shown in FIG. 3 is an ohmic resistance R which can have a relatively high resistance and which, for example, can have a value of 500 kOhm. As mentioned previously, this ohmic resistance R is used to unload the capacitor arrangement if the power supply filter FI is not fed by a power supply.

In addition to the components considered previously, the power supply low pass filter shown in FIG. 3 has a current-compensated choke DR with two windings W1, W2. One winding W1 lies in the line branch between the input connection EN and the output connection AN and the other winding W2 lies in the line branch between the input connection E0 and the output connection A0. This current-compensated choke is merely used to suppress common-mode interference signals which could originate from the power supply unit PS and which must not enter into the AC power supply line system. Both the relevant current-compensated choke DR and the high-resistance resistor R have no influence on the low-pass characteristic of the power supply low pass filter. The characteristic of the relevant power supply low pass filter is merely determined by the inductor component L and the capacitors C1, C2 and C3. The relevant capacitor arrangement can optionally be reduced to a single capacitor, such as the capacitor C1.

### REFERENCE LIST

TABLE 1

| | |
|---|---|
| A0 | Output connection |
| AN | Output connection |
| C1 | Capacitor |
| C1, C2, C3 | Capacitor arrangement |
| C2 | Capacitor |
| C3 | Capacitor |
| CT | Control device |
| DR | Current-compensated choke |
| E0 | Input connection |
| EN | Input connection |
| FI | Power supply filter, power supply low pass |
| | filter |
| G | Generator |
| HG | Household appliance |
| L | Inductive component, choke coil |
| MO | Transceiver, modem |
| N0 | Ground conductor |
| NL | Line conductor |
| PL | AC power supply line system |
| PS | Power supply unit |
| R | Ohmic resistor |
| W1 | Winding |
| W2 | Winding |
| Ze | Input impedance |
| Zfi | Impedance |
| Zn | Power supply line impedance |
| Zs | Impedance |
| Zü | Transmission line impedance |

1-5. (canceled)

6. A circuit configuration for transmitting data signals from and/or to household appliances, comprising:
a first transceiver device and a second transceiver device connected to transmit the data signals via an AC power supply line system within a transmission frequency range lying above a frequency of the AC power supply;
each said transceiver device including a power supply unit having an input circuit connected to the AC power supply line system via a power supply low-pass filter;
said power supply low-pass filter in said input circuit of said power supply unit having an impedance curve such that an impedance thereof in the transmission frequency range has a value at least twice as high as an impedance of the AC power supply line system in the transmission frequency range.

7. The circuit configuration according to claim 6, wherein the AC power supply line system includes at least one current-carrying line conductor and a ground conductor, said power supply low-pass filter is formed of an inductive component connected in the respective line conductor and a capacitor configuration connected between at least one end of the respective inductive component and said ground conductor.

8. The circuit configuration according to claim 7, wherein said capacitor configuration consists of a single capacitor connecting an end of said inductive component on a power supply unit side to said ground conductor of the AC power supply line system and a series circuit of two capacitors connected directly in parallel to said single capacitor, with a common node of said two capacitors connected to the ground connection of the respective power supply unit.

9. The circuit configuration according to claim 7, which comprises an ohmic resistor connected in parallel with said capacitor configuration.

10. The circuit configuration according to claim 6, which comprises one winding of a current-compensated choke respectively inserted in a conductor sections of said power supply low pass filter connected to the respective line conductor and a ground conductor of the AC power supply line system.
